(19) United States
(12) Patent Application Publication
(10) Pub. No.: US 2025/0258749 A1
(43) Pub. Date: Aug. 14, 2025

(54) Systems and methods for deploying independent pipelines in a cloud-based system

(71) Applicant: Zscaler, Inc., San Jose, CA (US)

(72) Inventor: Michael J. Melson, Arlington, MA (US)

(73) Assignee: Zscaler, Inc., San Jose, CA (US)

(21) Appl. No.: 18/436,126

(22) Filed: Feb. 8, 2024

(51) Int. Cl. G06F 11/34; G06F 11/36

(52) U.S. Cl. CPC G06F 11/3409; G06F 11/362

(57) ABSTRACT

Systems and methods for deploying independent pipelines in a cloud-based system include providing a service to a plurality of customers via a cloud-based system, wherein the service is adapted to receive requests and provide an output to perform a function for the plurality of customers; deploying one or more Independent Pipelines (IPs), wherein each of the one or more IPs comprises an instance of the service, and wherein the one or more IPs are independent of one another; feeding real production data through the service and each of the one or more IPs; and using an output from one of the service or any of the one or more IPs to perform the function of the service for the plurality of customers.

### FIELD OF THE DISCLOSURE

The present disclosure relates generally to networking and computing. More particularly, the present disclosure relates to systems and methods for deploying independent pipelines in a cloud-based system.

### BACKGROUND OF THE DISCLOSURE

Traditional methods of deploying code in cloud environments typically include testing new versions of code in various ways before implementation. Colorful deployments are a way of deploying code into an environment which allows for validation of the new code in production with minimal interference with live customers. The classic example of a colorful deployment is a blue/green deployment, where a new version of the code is deployed, and traffic/data is slowly routed into the new code path. Once the new code has proven itself stable and correct, all traffic/data is routed through it and the old code is removed. While this method is widely used, it introduces various drawbacks due to the new versions of the code being tested with actual live data and outputs from the new code being sent to customer environments. This means that if there is an issue with the new version of the code, the client will be affected.

### BRIEF SUMMARY OF THE DISCLOSURE

In an embodiment, the present disclosure includes a method with steps, a cloud-based system configured to implement the steps, and a non-transitory computer-readable medium storing computer-executable instructions for causing performance of the steps. The steps include providing a service to a plurality of customers via a cloud-based system, wherein the service is adapted to receive requests and provide an output to perform a function for the plurality of customers; deploying one or more Independent Pipelines (IPs), wherein each of the one or more IPs comprises an instance of the service, and wherein the one or more IPs are independent of one another; feeding real production data through the service and each of the one or more IPs; and using an output from one of the service or any of the one or more IPs to perform the function of the service for the plurality of customers.

The steps can further include wherein the one or more IPs each include a different version of the service, and wherein the steps further include validating each of the different versions of the service with the real production data. The service can be an original version of the service, wherein during the validating, the steps further include only sending outputs from the service to the plurality of customers, thereby enabling performance validation of each of the different versions of the service with real production data without impacting the plurality of customers. The steps can further include using an output from one of the service or any of the one or more IPs to perform the function of the service for the plurality of customers based on the validating. The steps can further include identifying a customer of the plurality of customers that utilizes a large amount of resource capacity; and assigning the identified customer to an IP of the one or more IPs, wherein the IP only processes data for the identified customer. Each of the one or more IPs can be deployed in its own isolated environment, wherein each of the IPs is isolated by data flow and hardware. The steps can further include deploying an IP, wherein the IP comprises an instance of the service, and wherein the IP is independent of the service; installing debugging code in the IP; and performing debugging of the service via the IP. The service can be an enforcement system adapted to enforce policy relating to security of the cloud-based system and the plurality of customers. Any of the plurality of customers can be assigned to any of the one or more IPs, wherein assigning a customer to an IP causes the IP to process all requests for the customer. Any number of IPs can be deployed, wherein each of the IPs can be configured to ingest all the data flowing through the service.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of a cloud-based system offering security as a service.

FIG. 1B is a logical diagram of the cloud-based system operating as a zero-trust platform.

FIG. 1C is a logical diagram illustrating zero trust policies with the cloud-based system and a comparison with the conventional firewall-based approach.

FIG. 2 is a network diagram of an example implementation of the cloud-based system.

FIG. 3 is a block diagram of a server, which may be used in the cloud-based system, in other systems, or standalone.

FIG. 4 is a block diagram of a user device, which may be used with the cloud-based system or the like.

FIG. 5 is a network diagram of a Zero Trust Network Access (ZTNA) application utilizing the cloud-based system.

FIG. 6 is a network diagram of the cloud-based system in an application of digital experience monitoring.

FIG. 7 is a network diagram of the cloud-based system illustrating an application on user devices with users configured to operate through the cloud-based system.

FIG. 8 is a flow chart of a process for creating and utilizing Independent Pipelines (IPs).

### DETAILED DESCRIPTION OF THE DISCLOSURE

Cloud-based security solutions have emerged, such as Zscaler Internet Access (ZIA) and Zscaler Private Access (ZPA), available from Zscaler, Inc., the applicant and assignee of the present application. ZPA is a cloud service that provides seamless, zero trust access to private applications running on the public cloud, within the data center, within an enterprise network, etc. As described herein, ZPA is referred to as zero trust access to private applications or simply a zero trust access service. Here, applications are never exposed to the Internet, making them completely invisible to unauthorized users. The service enables the applications to connect to users via inside-out connectivity versus extending the network to them. Users are never placed on the network. This Zero Trust Network Access (ZTNA) approach supports both managed and unmanaged devices and any private application (not just web apps).

### Example Cloud-Based System Architecture

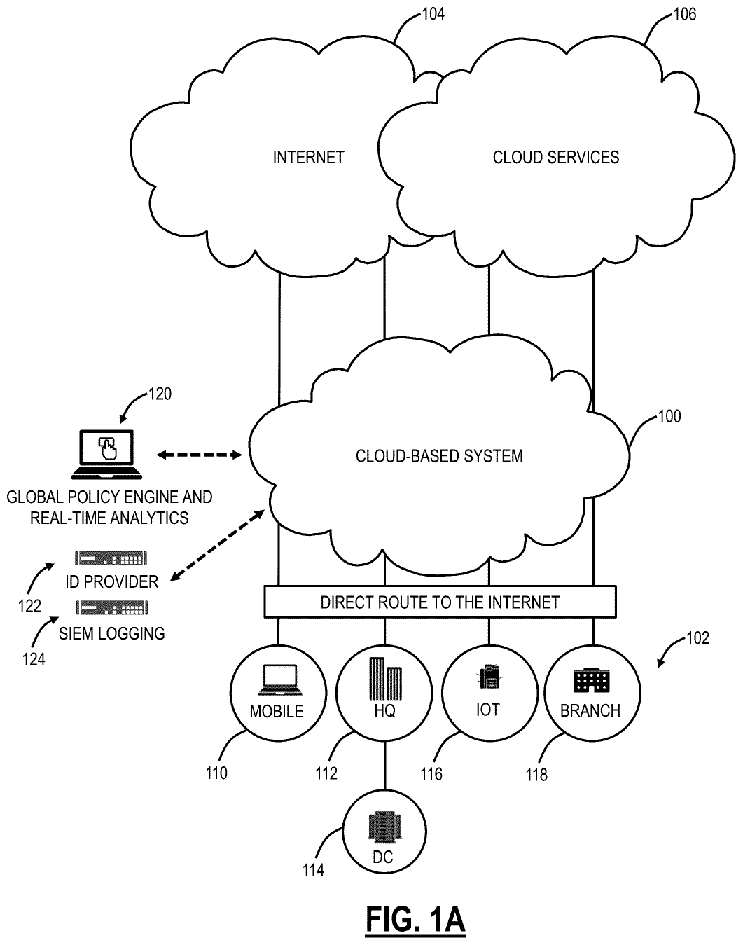

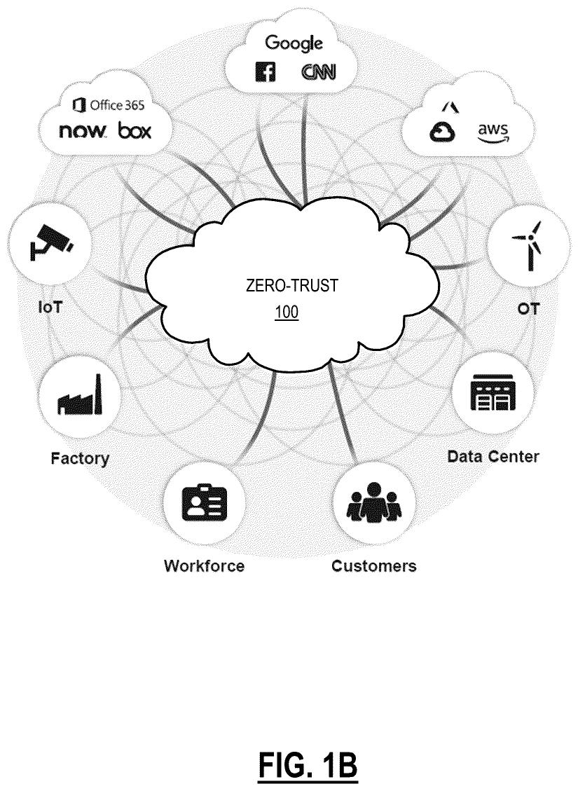

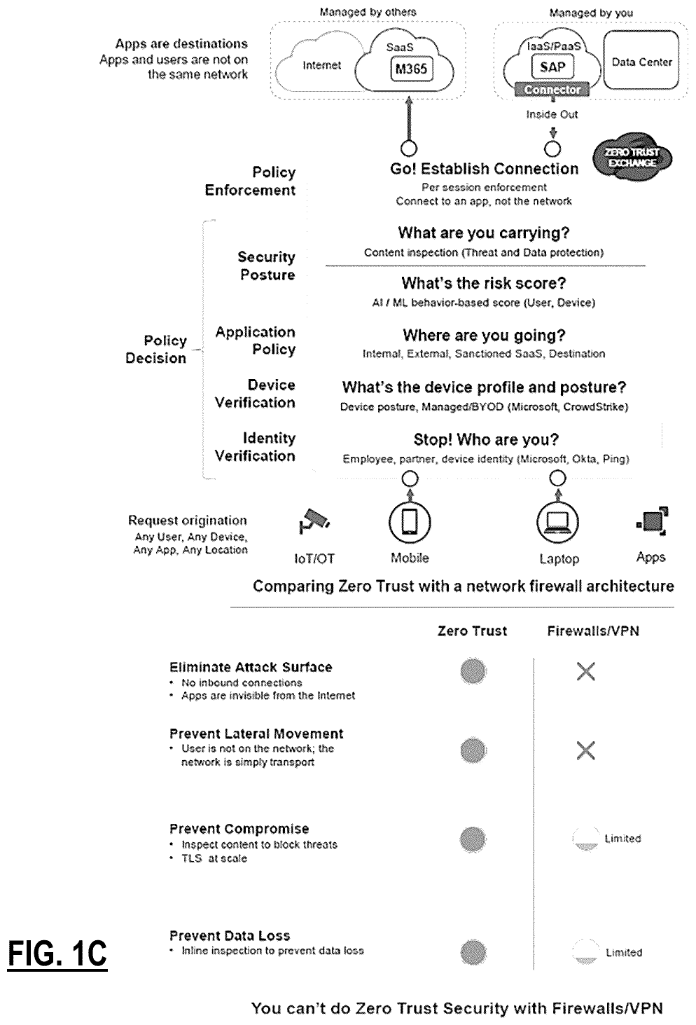

FIG. 1A is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via a Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

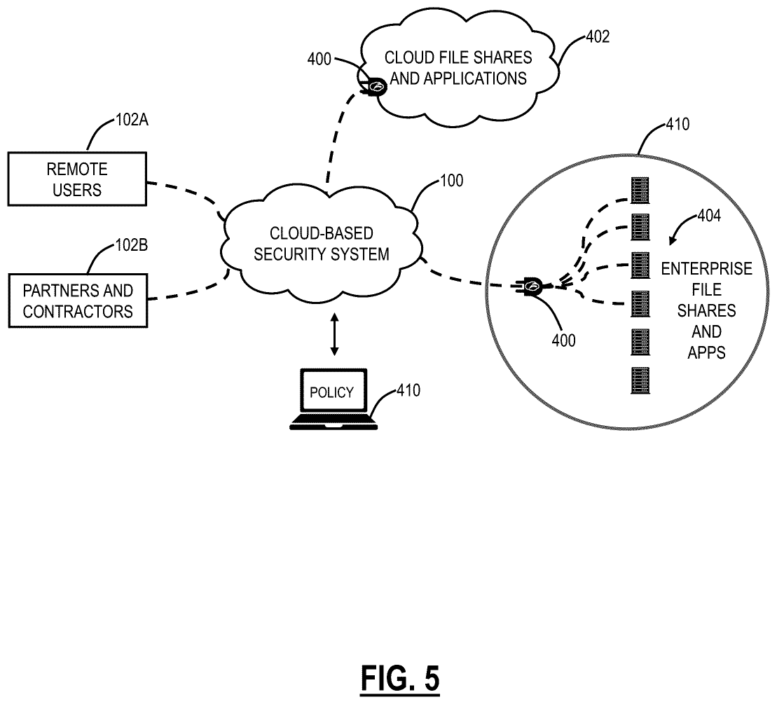

For illustration purposes, the users 102 of the cloud-based system 100 can include a mobile device 110, a headquarters (HQ) 112 which can include or connect to a data center (DC) 114, Internet of Things (IoT) devices 116, a branch office/remote location 118, etc., and each includes one or more user devices (an example user device 300 is illustrated in FIG. 5). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc. Those skilled in the art will recognize a user 102 has to use a corresponding user device 300 for accessing the cloud-based system 100 and the like, and the description herein may use the user 102 and/or the user device 300 interchangeably.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes-they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. An application of the local application is the application 350 described in detail herein as a connector application. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

### Zero Trust

FIG. 1B is a logical diagram of the cloud-based system 100 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud-based system 100. Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud-based system 100. Critically, in a zero trust architecture, a resource's network location is not the biggest factor in its security posture anymore. Instead of rigid network segmentation, your data, workflows, services, and such are protected by software-defined microsegmentation, enabling you to keep them secure anywhere, whether in your data center or in distributed hybrid and multicloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

FIG. 1C is a logical diagram illustrating zero trust policies with the cloud-based system 100 and a comparison with the conventional firewall-based approach. Zero trust with the cloud-based system 100 allows per session policy decisions and enforcement regardless of the user 102 location. Unlike the conventional firewall-based approach, this eliminates attack surfaces, there are no inbound connections; prevents lateral movement, the user is not on the network; prevents compromise, allowing encrypted inspection; and prevents data loss with inline inspection.

### Example Implementation of the Cloud-Based System

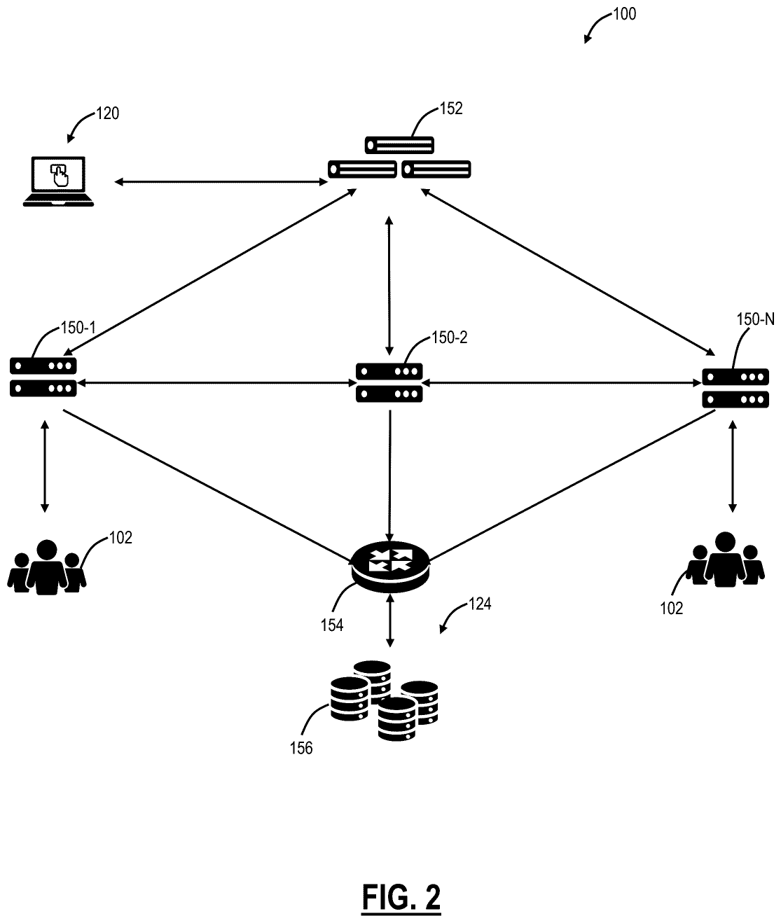

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150 and the central authority 152, while described as nodes, can include one or more servers, including physical servers, virtual machines (VM) executed on physical hardware, etc. An example of a server is illustrated in FIG. 4. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

Of note, the cloud-based system 100 is an external system meaning it is separate from tenant's private networks (enterprise networks) as well as from networks associated with the devices 110, 116, and locations 112, 118. Also, of note, the present disclosure describes a private enforcement node 150P that is both part of the cloud-based system 100 and part of a private network. Further, of note, the enforcement node described herein may simply be referred to as a node or cloud node. Also, the terminology enforcement node 150 is used in the context of the cloud-based system 100 providing cloud-based security. In the context of secure, private application access, the enforcement node 150 can also be referred to as a service edge or service edge node. Also, a service edge node 150 can be a public service edge node (part of the cloud-based system 100) separate from an enterprise network or a private service edge node (still part of the cloud-based system 100) but hosted either within an enterprise network, in a data center 114, in a branch office 118, etc. Further, the term nodes as used herein with respect to the cloud-based system 100 (including enforcement nodes, service edge nodes, etc.) can be one or more servers, including physical servers, virtual machines (VM) executed on physical hardware, etc., as described above. The service edge node 150 can also be a Secure Access Service Edge (SASE).

The enforcement nodes 150 are full-featured secure internet gateways that provide integrated internet security. They inspect all web traffic bi-directionally for malware and enforce security, compliance, and firewall policies, as described herein, as well as various additional functionality. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure Transport Layer Security (TLS) connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is processed through one of the enforcement nodes 150.

Each of the enforcement nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). Also, there can be multiple different cloud-based systems 100, including ones with different architectures and multiple cloud services. The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

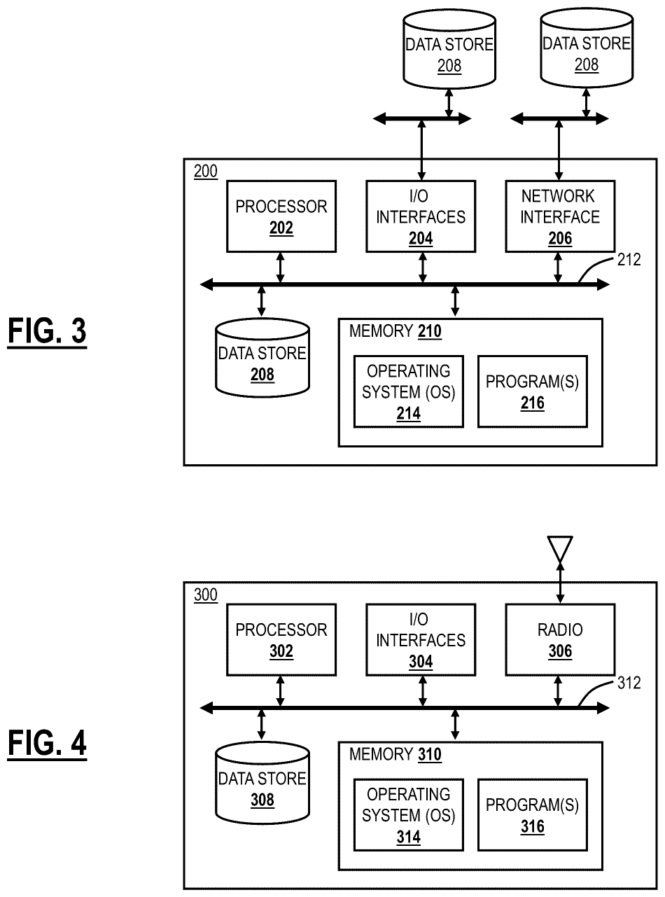

FIG. 3 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 4 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### Zero Trust Network Access Using the Cloud-Based System

FIG. 5 is a network diagram of a Zero Trust Network Access (ZTNA) application utilizing the cloud-based system 100. For ZTNA, the cloud-based system 100 can dynamically create a connection through a secure tunnel between an endpoint (e.g., users 102A, 102B) that are remote and an on-premises connector 400 that is either located in cloud file shares and applications 402 and/or in an enterprise network 410 that includes enterprise file shares and applications 404. The connection between the cloud-based system 100 and on-premises connector 400 is dynamic, on-demand, and orchestrated by the cloud-based system 100. A key feature is its security at the edge—there is no need to punch any holes in the existing on-premises firewall. The connector 400 inside the enterprise (on-premises) “dials out” and connects to the cloud-based system 100 as if too were an endpoint. This on-demand dial-out capability and tunneling authenticated traffic back to the enterprise is a key differentiator for ZTNA. Also, this functionality can be implemented in part by an application 350 on the user device 300. Also, the applications 402, 404 can include B2B applications. Note, the difference between the applications 402, 404 is the applications 402 are hosted in the cloud, whereas the applications 404 are hosted on the enterprise network 410. The services described herein contemplates use with either or both of the applications 402, 404.

The paradigm of virtual private access systems and methods is to give users network access to get to an application and/or file share, not to the entire network. If a user is not authorized to get the application, the user should not be able even to see that it exists, much less access it. The virtual private access systems and methods provide an approach to deliver secure access by decoupling applications 402, 404 from the network, instead of providing access with a connector 400, in front of the applications 402, 404, an application on the user device 300, a central authority 152 to push policy, and the cloud-based system 100 to stitch the applications 402, 404 and the software connectors 400 together, on a per-user, per-application basis.

With the virtual private access, users can only see the specific applications 402, 404 allowed by the central authority 152. Everything else is “invisible” or “dark” to them. Because the virtual private access separates the application from the network, the physical location of the application 402, 404 becomes irrelevant-if applications 402, 404 are located in more than one place, the user is automatically directed to the instance that will give them the best performance. The virtual private access also dramatically reduces configuration complexity, such as policies/firewalls in the data centers. Enterprises can, for example, move applications to Amazon Web Services or Microsoft Azure, and take advantage of the elasticity of the cloud, making private, internal applications behave just like the marketing leading enterprise applications. Advantageously, there is no hardware to buy or deploy because the virtual private access is a service offering to end-users and enterprises.

### Digital Experience Monitoring

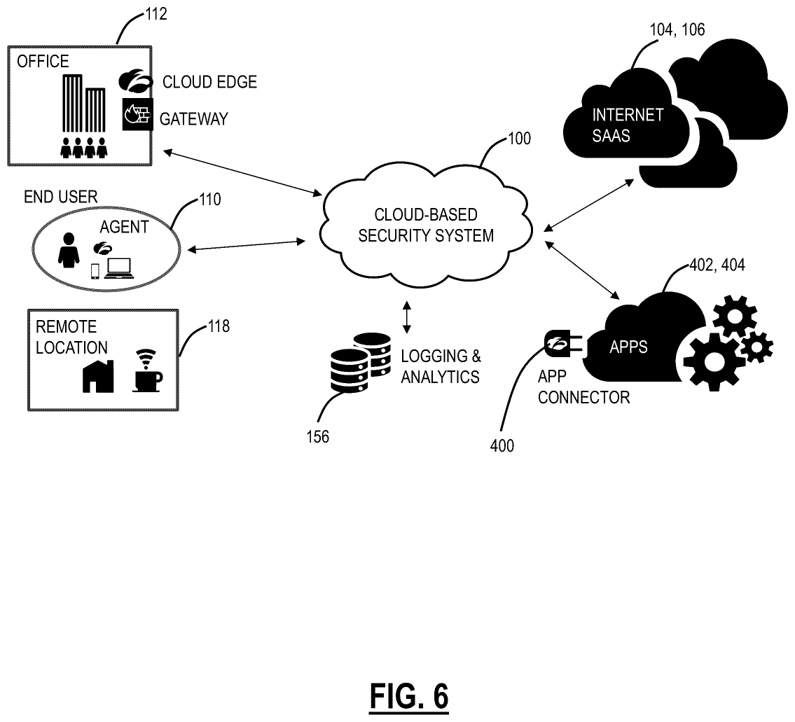

FIG. 6 is a network diagram of the cloud-based system 100 in an application of digital experience monitoring. Here, the cloud-based system 100 providing security as a service as well as ZTNA, can also be used to provide real-time, continuous digital experience monitoring, as opposed to conventional approaches (synthetic probes). A key aspect of the architecture of the cloud-based system 100 is the inline monitoring. This means data is accessible in real-time for individual users from end-to-end. As described herein, digital experience monitoring can include monitoring, analyzing, and improving the digital user experience.

The cloud-based system 100 connects users 102 at the locations 110, 112, 118 to the applications 402, 404, the Internet 104, the cloud services 106, etc. The inline, end-to-end visibility of all users enables digital experience monitoring. The cloud-based system 100 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud-based system 100 provides a unique architecture that can enable digital experience monitoring, network application monitoring, infrastructure component interactions, etc. Of note, these various monitoring aspects require no additional components—the cloud-based system 100 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 100 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 100 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 100 can operate at 10 gigabits (10G) Ethernet and higher at full line rate and support a rate of 100,000 or more flows per second or higher.

The applications 402, 404 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 350 or the cloud edge to quantify user experience for specific applications, i.e., the application-related and device-related data. The cloud-based system 100 can further collect the network-related and the protocol-related data (e.g., Domain Name System (DNS) response time).

Application-related data

| | |
|---|---|
| Page Load Time | Redirect count (#) |
| Page Response Time | Throughput (bps) |
| Document Object Model (DOM) | Total size (bytes) |
| Load Time | |
| Total Downloaded bytes | Page error count (#) |
| App availability (%) | Page element count by category (#) |

Network-related data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

Device-related data (endpoint-related data)

| | |
|---|---|
| System details | Network (config) |
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 100 can generate service health as a combination of CPU, memory, and the load time of the service while processing a user's request. The network health could be based on the number of network path(s), latency, packet loss, etc.

The lightweight connector 400 can also generate similar metrics for the applications 402, 404. In an embodiment, the metrics can be collected while a user is accessing specific applications that user experience is desired for monitoring. In another embodiment, the metrics can be enriched by triggering synthetic measurements in the context of an inline transaction by the application 350 or cloud edge. The metrics can be tagged with metadata (user, time, app, etc.) and sent to a logging and analytics service for aggregation, analysis, and reporting. Further, network administrators can get UEX reports from the cloud-based system 100. Due to the inline nature and the fact the cloud-based system 100 is an overlay (in-between users and services/applications), the cloud-based system 100 enables the ability to capture user experience metric data continuously and to log such data historically. As such, a network administrator can have a long-term detailed view of the network and associated user experience.

### User Device Application for Traffic Forwarding and Monitoring

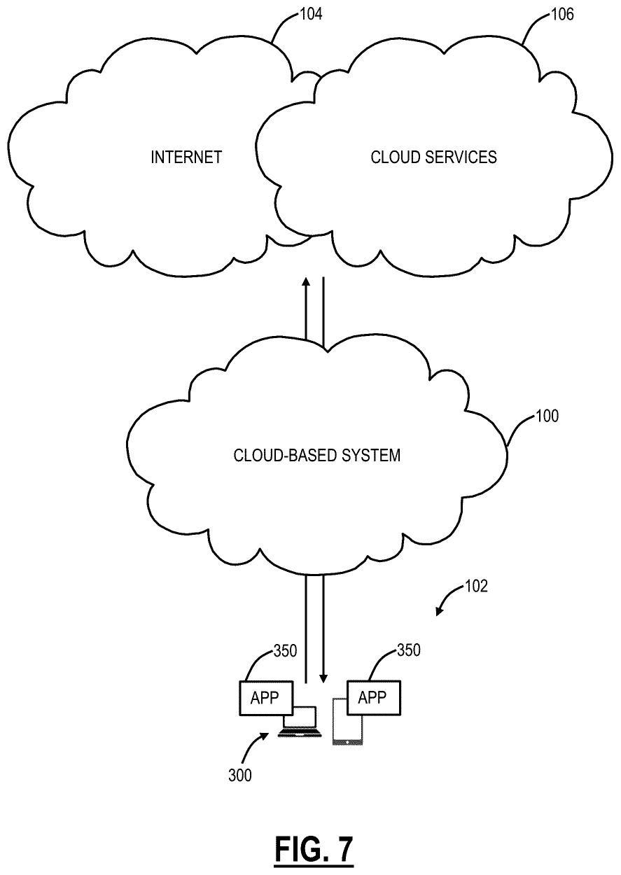

FIG. 7 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best-in-class security with zero trust access to internal apps. As described herein, the application 350 can also be referred to as a connector application.

The application 350 is configured to auto-route traffic for seamless user experience. This can be protocol as well as application-specific, and the application 350 can route traffic with a nearest or best fit enforcement node 150. Further, the application 350 can detect trusted networks, allowed applications, etc. and support secure network access. The application 350 can also support the enrollment of the user device 300 prior to accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPsec VPN, authentication cookies, or user 102 setup.

### Independent Pipelines (IPs)

Traditionally, to roll out new code, for example new versions of services in a cloud environment, colorful deployment methods are utilized. Colorful deployments are a way of deploying code into an environment which allows for validation of the new code in production with minimal interference to live customers. The classic example of a colorful deployment is the blue/green deployment, where a new version of the code is deployed, and traffic/data is slowly routed into the new code path. Once the new code has proven itself stable and correct, all traffic/data is routed through it and the old code is removed. The present disclosure provides a more efficient deployment method which provides flexibility and customization.

In a typical blue/green deployment, a current version of code is referred to as the blue version while a new version of the code is referred to as the green version, the current version of the code being the version currently running on the system. With typical methods, such as the blue/green deployment method, the deployments/versions are run side-by-side. They both receive portions of the requests and send outputs/write to databases and/or send responses to clients. This means that if there is an issue with the new version of the code, the client will be affected because both, i.e., the new code and old code, are processing requests and sending responses even if there is an issue with the new version.

The present systems and methods utilize simultaneous deployments of code that run completely independently to perform a plurality of different tasks including new version rollout, code testing and validation, customer isolation, etc. These independent instantiations of code are referred to as Independent Pipelines (IPs), because they run completely independent of each other. In various examples, the present disclosure refers to an enforcement system, the enforcement system of the present disclosure being the code referred to in the various examples. In various embodiments, an Independent Enforcement Pipeline (IEP) is an instantiation of new code, for example, a new version of the enforcement system code. In an embodiment, an IEP can be an instantiation of a new enforcement system, such as a combination of the various cloud security services described herein, done in such a way that each IEP is segregated for all other IEPs. This provides the ability to deploy new code in a way that allows testing at scale, validating correctness with production data, and otherwise making changes that are incompatible with previous versions of the enforcement system. The present deployment process doesn't require any downtime, since the old system continues to run, allowing administrators to be much more thorough. Additionally, it allows for easy cleanup by gathering all associated topics in one easy-to-delete collection of topics, the topics referring to Apache Kafka topics or any other structured data store.

The present disclosure references an enforcement system. An enforcement system can be contemplated as a part of a cloud security system that takes policy/rule inputs and compiles them in a form that allows agents across the cloud-based system to make actionable decisions on traffic. That is, the enforcement system utilizes customer policy, and instructs agents across the cloud-based system to perform the various security actions described herein. in other words, the enforcement system can be referred to as a service provided via the cloud-based system, wherein the service is adapted to receive requests and provide an output to perform a function for the plurality of customers, the function being the various actionable security decisions made on traffic.

It will be appreciated that although the present disclosure references the “code” as being the enforcement system described herein, the present systems and methods can be utilized to facilitate the new version rollout, code testing and validation, customer isolation, etc. for any code or service having inputs and outputs.

The various embodiments described herein provide a system that can support simultaneous deployments of a plurality of IPs and allows administrators to switch customers to any of the IPs with no interruption of service. While the present systems and methods can be used for deploying any code in a cloud-based system, the various examples described herein focus on deployment of new enforcement pipelines, i.e., the various cloud security systems described herein.

In an exemplary use case, the present systems and methods can be utilized for zero-downtime code-only deployments. The systems are fully automated and provide more opportunities to verify the deployment before subjecting customers to it. Additionally, because brand new parallel pipelines are started, changes which may not be currently supported, such as pipeline topology changes, work out of the box. Further, none of the deployments require any customer downtime because they are switched over in a nearly automatic operation. That is, they go from their previous enforcement pipeline to their new enforcement pipeline without interruption.

The way that traditional blue/green deployments work includes having a current system (version 1) running. A new copy of the system (version 2) including various changes is then deployed. Requests can then be slowly moved from entering version 1 to version 2. If at any point there is a bug detected, all of the requests can simply be routed back to version 1, and version 2 of the system can be torn down. If no bugs are detected in version 2, and 100% of the requests are being processed by version 2 of the system, the original system, i.e., version 1, can be torn down.

With IPs, the process starts with version 1 running in the production environment, i.e., the original service. In order to deploy a new version, version 2, a new IP is created to run version 2. Once the IP is deployed, the code is installed, and the systems begin processing all of the data, including all historic data. Once the IP has processed all of the data, testing can be performed to validate its output and make sure it is performing as expected. During this testing, all outputs reaching customer environments come solely from version 1. Then, once validation is complete, a configuration option can be changed that switches the output from version 1 to version 2, and from that point on, version 2 is responsible for updating data in customer environments. Version 1 can be retained or torn down. This results in an upgraded system with no downtime. This also improves on the traditional blue/green method because if a bug is detected, it isn't with data that would be affecting customers. In traditional blue/green deployments, if a request triggers a bug in the new code, the request is thrown out and the customer must make a new request to be processed by the original system. This is mitigated by the present systems and methods because one can select which versions output reaches the customers.

That is, utilizing the present systems and methods, one can select which one of the outputs is desired to be active when a plurality of IPs are deployed. This enables processing of all data without customers being affected. For example, with reference to the colorful deployments, while the customer is running on the blue system, the output switch can be selected to blue. This means that anything that happens in the green system doesn't matter because the outputs from the green system are not used. Each of the instances of the enforcement pipeline run within its own sandbox, so when a new IP is established, it rebuilds the current state of the system, i.e., it catches up to where the active one is. And nothing that happens within it has an affect on the outside world until it is directed to do so. At that point, there can be any number of IPs running simultaneously, with each of them ingesting and processing all the customer data/requests. By utilizing the output selection feature, administrators can select which IPs outputs actually reach the customers. Again, this allows the ability to assign customers to different IPs.

In another use case, the present systems and methods can be utilized for partition count changes, referring to Apache Kafka. Changing the partition count for topics in a current pipeline is essentially impossible without micromanaging every topic, both internal and user-defined, along the entire pipeline. By utilizing IPs, this process becomes as simple as deploying a new pipeline and switching customers over to it. This enables the ability to make fundamental architectural changes that differ between instances.

In another use case, the present systems and methods can be utilized for customer isolation. Because a plurality of IPs can run side-by-side, customers can be provisioned their own long-term IP. For example, customer A can be a resource costly customer who takes up more than their share of enforcement resource capacity. Instead of having to spin up an entirely new production environment, administrators can simply deploy an IP for them and only assign their site to it. This can be done at any time, including after a customer has been assigned to a production environment. This means that if a site becomes too resource expensive or otherwise needs to be isolated, the present systems and methods can be utilized to isolate it at any time.

For example, there are 10 customers, and all the customers are assigned to IP1. If one of those customers is growing substantially and needs to deploy more agents or traffic has increased considerably leaving the other customers with little bandwidth to share, administrators can move that customer out of that environment. In an embodiment, two new IPs can be deployed, IP2 and IP3. The growing customer can be assigned to IP2 so that IP2 only processes data for that one customer. The remaining customers can be assigned to IP3, where they continue to share that environment. IP1 can now either be torn down or retained while both IP2 and IP3 are run long term with IP2 servicing the one larger customer and IP3 servicing the remaining customers, thereby providing a better experience for all customers.

The steps described for isolation can be initiated by identifying a customer of a plurality of customers that utilizes a large amount of resource capacity, i.e., a customer that is growing substantially. Based on this, that customer can be assigned to an IP, wherein the IP only processes data for the identified customer.

In another use case, the present systems and methods can be utilized to facilitate debugging. In order to debug problems in production, it is sometimes required to be in production. The present systems can be used to deploy an IP configured to enable debugging, which would allow users to make use of real production data, in real time, without interfering with enforcement at customer sites. This allows administrators to verify the code before switching customers over to the new version and making it active. This also allows administrators to install special debugging code which would never be done in a production environment due to performance reasons. This is possible because each IP is essentially a production environment, the only difference being whether the outputs are used or not. Administrators can then take advantage of the installed debugging code to perform debugging of the service via the IP with real production data without having to worry about impacting performance.

In another use case, the present systems and methods can be utilized for scale and performance testing. In cloud environments, sometimes it is necessary to test features at scale. An IP can be deployed with profiling enabled allowing administrators to assess new changes and find hot spots that need improvement. Because each IP can ingest all incoming requests, this also provides access to the full production deployments data flows, thus representing current, actual, real data and usage patterns.

Utilizing the present systems and methods increases the level of control, meaning administrators can select which customers are affected by which IP. Unlike traditional blue/green deployment, with IPs, it is intended to run with multiple copies of the system running at the same time. They can process the same customer or different customers and they can be scaled completely independently. Different tenants of the cloud-based system can be running on different versions of the enforcement pipeline, i.e., different versions of code. Further, in various embodiments, each IP runs on its own systems. That is, whenever a new IP is deployed, it is spun up its own isolated environment, so it is isolated not only by data flow, but also hardware to isolate CPU usage and other hardware usage.

Each of the IPs can be configured to ingest all the data flowing through the original pipeline. That is, each of the IPs can be running on 100% of the input data, allowing administrators to run all the data through new systems without affecting the customers environment. Because of this, and by providing the ability to select which IPs outputs are being sent to customers, administrators have increased flexibility when testing new versions of code such as the enforcement pipeline. As described, this also provides the ability to isolate specific customers based on hardware needs, security, and the like.

The present examples contemplate utilizing the systems and methods for deployment of enforcement pipelines because it is a data dead-end. The enforcement pipeline has the benefit of not having any of its produced data consumed by services outside itself. This means the systems can effectively attach any number of pipelines to the rest of the system and, by controlling sending outputs to agents at the end of each instance of the enforcement pipeline, any given pipeline does not need to know if or how many others exist. Furthermore, the rest of the system also does not need to know if, when, or how many pipelines are attached. Although the present examples reference enforcement pipelines, the present systems and methods can be utilized to deploy, troubleshoot, test, isolate, etc. any code, service, or the like on a per-customer basis. Although the term Independent Enforcement Pipeline (IEP) is used herein, it specifically refers to an Independent Pipeline (IP) which includes the enforcement systems described herein. That is, an IEP is and IP which contains “enforcement” system code, and the term IP can be used interchangeably with the term IEP when referring to other types of code.

In various embodiments, each IEP can be activated on a per-site basis. This activation can be facilitated via an enforcement selector to allow for IEP selection. This can be provided to administrators, or other administering individuals, via a User Interface (UI). When switching between IEPs, agent updates are disabled in the site's currently active IEP and enabled for the sites new IEP. The systems can then force a round of fulls to be sent. This is done online without any necessary notification to the customer, and if something goes wrong, the systems can be used to reverse the process and put them back on the old system. This example describes the mechanism by which the systems are able to switch a site between various IEPs without requiring any significant downtime. To do so, the systems stop emitting output from the currently active IEP, perform the switch, and then sync the output of the new IEP from scratch. In case an error is discovered, the systems simply perform the same steps in reverse to restore the system to the initial state.

In an embodiment, all IEPs are adapted to process data for all sites by default, but by allowing administrators to filter inputs at the top, it allows IEPs to function not only as a colorful deployment mechanism, but also as a way to segregate sites that need or want to not share enforcement data with other customers.

In various embodiments, enforcement pipelines include defined namespaces for streaming apps and topics. These namespaces contain the deployment color (version) and any relevant data. For streaming apps, a namespace can be in the following format <color>-iep-<service>-<stream app id>. This format can be easily built with a topic name decoration method, such as those used within Apache Kafka itself to build internal topic names. This has the benefit of allowing the final namespace to be built in a way that is transparent to the stream apps themselves, using a new environment variable for the deployment color and the preexisting component name environment variable. The topics follow the same namespace-based naming conventions as stream apps. Internal topics are named based on the following format <color>-iep-<service>-<stream app id>-<topic-name>-changelog/repartition.

When possible, user-defined topics have their lifecycle tied to the producer of a particular topic. By having a clear owner (or in some embodiments owners) of a topic it is possible to make straightforward decisions about when a topic can be removed when a stream app is removed. Thus, the naming convention for user-defined topics can be <color>-iep-<service>-<stream app id>-<topic-name>. There are some cases, such as during decomp and tracking, where multiple stream apps will emit into the same topic. In these cases, individual output topics and a simple multiplexer stream app can be added to avoid the many-to-one production. Thus, the naming convention can be <color>-iep-<service>-<topic name>, for example, the output topic from a tracker service can be “blue-iep-tracker-partial-changes”.

In order for the various IEPs to interact with external components, for inbound data, changelog inputs start from the beginning, non-changelog need inputs must be replayable and/or not be required. That is, the various pipelines must be entirely self-contained (i.e. must not interact with external components) and must be able to be reconstructed from scratch based entirely on data that is stored outside the pipeline. This ensures that these pipelines do not interfere with each other and can be created and destroyed without any loss of data.

Because each of the IEPs have the ability to be configured separately, the underlying data streaming infrastructure can be configured in various ways. In one embodiment, the data streaming infrastructure, such as Apache Kafka, can be configured in an environment mode. For example, this environment mode enables an IEP to use the Kafka cluster configured to run the rest of the environment. Environment mode is equivalent to what is done for a current non-IEP enforcement pipeline. Environment mode is best suited for and should be relegated to DODs and other special-purpose deployments. Benefits include not needing to create any additional infrastructure when deploying an IEP.

When configured in an isolation mode, each IEP gets an entire Kafka cluster dedicated just to that IEP. In isolated mode, input topics are synced from the environment's Kafka cluster using a tool such as MirrorMaker, and the only other topics it needs to manage are those belonging to the IEP. This mode is useful when coupled with customer isolation, so that customers can be moved somewhere they won't be bothered by other customers. Benefits include much lower stress placed on each Kafka cluster, which leads to better stability and performance. Since there are fewer topics, this mode also allows for (optionally) more partitions to improve parallelism without requiring migration to a different stream processing technology such as Flink. Also, cleanup is even easier because there is no management of individual topics, the whole cluster is simply deleted.

Finally, a shared mode involves multiple IEPs sharing a single Kafka cluster, but that Kafka cluster is separate from the cluster underlying the rest of the environment. This is especially useful for saving time and money on small and Proof of Concept (POC) sites.

Each of the IEPs get to be individually configured for a specific mode upon deployment, making it possible that many sites start in shared mode and as they progress, they can be moved into isolated mode, i.e., move them to their own cluster. Due to the ease of deploying and moving customers to new IEPs, any incorrect cluster mode assignments can be easily remedied.

### IP Deployment

Deploying a new IP can be done independent of any existing IPs (hence “independent”). The following steps can be taken to deploy new IPs. First, an unused IP identifier must be selected, for example, in reference to the traditional colorful deployment methods, colors can be used for IP identifiers. Next, the various user-defined topics are created with the chosen color. Once the user-defined topics are created, all of the services for the IP can be deployed. Once all services start, if necessary, one can replay into any input topics that may require it. Optionally, once the log catches up, a test site can be activated in the IP and the correctness can be verified with the enforcement suite. Then, each site can be activated site-by-site on the IP for any lag to be processed. More specifically, the process can include selecting a short word or phrase as an identifier, creating the underlying infrastructure that will run the IP (i.e., creating topics, deploying servers, etc.), deploy the services which make up the IP to the new infrastructure, wait for the IP to regenerate all of its data, perform any desired quality checks, and activate the IP for any sites.

To destroy an IP, a deployed IP is chosen. The IP is assessed to make sure that there are no active sites on the IP. Any tasks are stopped and removed along with other services belonging to the IP. Then, all topics starting with the pattern <color>-iep-* are deleted, the <color> field identifying the specific IP being destroyed.

To facilitate the present systems and methods, an enforcement selector, i.e., a UI adapted to allow selection of enforcement characteristics for customers, is upgraded to support selections for old enforcement, new enforcement, and IPs. Once that is done one can simply deploy an IP using the steps above.

### Process for Creating and Utilizing IPs

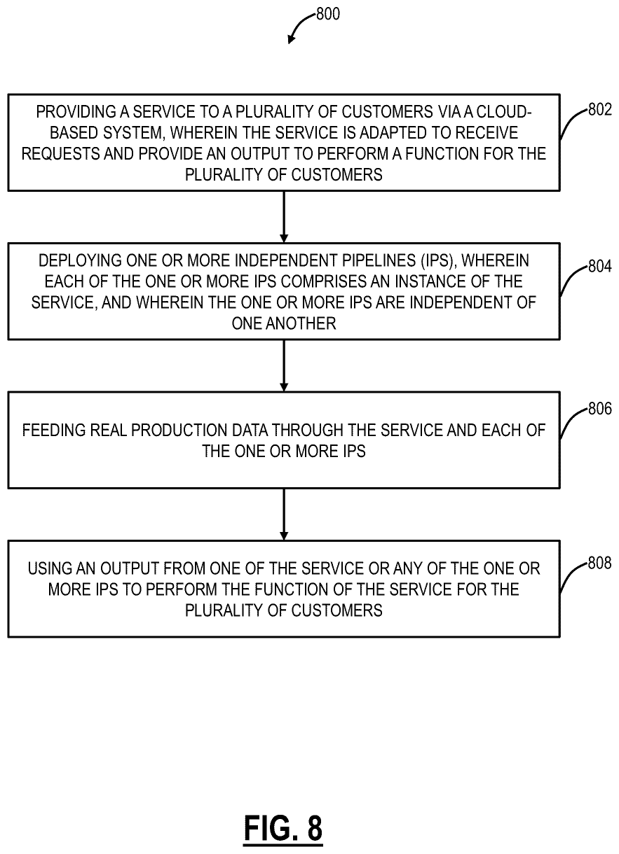

FIG. 8 is a flow chart of a process for creating and utilizing Independent Pipelines (IPs). The process 800 includes providing a service to a plurality of customers via a cloud-based system, wherein the service is adapted to receive requests and provide an output to perform a function for the plurality of customers (step 802); deploying one or more Independent Pipelines (IPs), wherein each of the one or more IPs comprises an instance of the service, and wherein the one or more IPs are independent of one another (step 804); feeding real production data through the service and each of the one or more IPs (step 806); and using an output from one of the service or any of the one or more IPs to perform the function of the service for the plurality of customers (step 808).

The process 800 can further include wherein the one or more IPs each include a different version of the service, and wherein the steps further include validating each of the different versions of the service with the real production data. The service can be an original version of the service, wherein during the validating, the steps further include only sending outputs from the service to the plurality of customers, thereby enabling performance validation of each of the different versions of the service with real production data without impacting the plurality of customers. The steps can further include using an output from one of the service or any of the one or more IPs to perform the function of the service for the plurality of customers based on the validating. The steps can further include identifying a customer of the plurality of customers that utilizes a large amount of resource capacity; and assigning the identified customer to an IP of the one or more IPs, wherein the IP only processes data for the identified customer. Each of the one or more IPs can be deployed in its own isolated environment, wherein each of the IPs is isolated by data flow and hardware. The steps can further include deploying an IP, wherein the IP comprises an instance of the service, and wherein the IP is independent of the service; installing debugging code in the IP; and performing debugging of the service via the IP. The service can be an enforcement system adapted to enforce policy relating to security of the cloud-based system and the plurality of customers. Any of the plurality of customers can be assigned to any of the one or more IPs, wherein assigning a customer to an IP causes the IP to process all requests for the customer. Any number of IPs can be deployed, wherein each of the IPs can be configured to ingest all the data flowing through the service.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method comprising steps of:
providing a service to a plurality of customers via a cloud-based system, wherein the service is adapted to receive requests and provide an output to perform a function for the plurality of customers;
deploying one or more Independent Pipelines (IPs), wherein each of the one or more IPs comprises an instance of the service, and wherein the one or more IPs are independent of one another;
feeding real production data through the service and each of the one or more IPs; and
using an output from one of the service or any of the one or more IPs to perform the function of the service for the plurality of customers.

2. The method of claim 1, wherein the one or more IPs each comprise a different version of the service, and wherein the steps further comprise validating each of the different versions of the service with the real production data.

3. The method of claim 2, wherein the service is an original version of the service, and wherein during the validating, the steps further comprise only sending outputs from the service to the plurality of customers, thereby enabling performance validation of each of the different versions of the service with real production data without impacting the plurality of customers.

4. The method of claim 2, wherein the steps further comprise using an output from one of the service or any of the one or more IPs to perform the function of the service for the plurality of customers based on the validating.

5. The method of claim 1, wherein the steps comprise:
identifying a customer of the plurality of customers that utilizes a large amount of resource capacity; and
assigning the identified customer to an IP of the one or more IPs, wherein the IP only processes data for the identified customer.

6. The method of claim 5, wherein each of the one or more IPs is deployed in its own isolated environment, and wherein each of the IPs is isolated by data flow and hardware.

7. The method of claim 1, wherein the steps comprise:
deploying an IP, wherein the IP comprises an instance of the service, and wherein the IP is independent of the service;
installing debugging code in the IP; and
performing debugging of the service via the IP.

8. The method of claim 1, wherein the service is an enforcement system adapted to enforce policy relating to security of the cloud-based system and the plurality of customers.

9. The method of claim 1, wherein any of the plurality of customers can be assigned to any of the one or more IPs, wherein assigning a customer to an IP causes the IP to process all requests for the customer.

10. The method of claim 1, wherein any number of IPs can be deployed, and wherein each of the IPs can be configured to ingest all the data flowing through the service.

11. A non-transitory computer-readable medium comprising instructions that, when executed, cause one or more processors to perform steps of:
providing a service to a plurality of customers via a cloud-based system, wherein the service is adapted to receive requests and provide an output to perform a function for the plurality of customers;
deploying one or more Independent Pipelines (IPs), wherein each of the one or more IPs comprises an instance of the service, and wherein the one or more IPs are independent of one another;
feeding real production data through the service and each of the one or more IPs; and
using an output from one of the service or any of the one or more IPs to perform the function of the service for the plurality of customers.

12. The non-transitory computer-readable medium of claim 11, wherein the one or more IPs each comprise a different version of the service, and wherein the steps further comprise validating each of the different versions of the service with the real production data.

13. The non-transitory computer-readable medium of claim 12, wherein the service is an original version of the service, and wherein during the validating, the steps further comprise only sending outputs from the service to the plurality of customers, thereby enabling performance validation of each of the different versions of the service with real production data without impacting the plurality of customers.

14. The non-transitory computer-readable medium of claim 12, wherein the steps further comprise using an output from one of the service or any of the one or more IPs to perform the function of the service for the plurality of customers based on the validating.

15. The non-transitory computer-readable medium of claim 11, wherein the steps comprise:
identifying a customer of the plurality of customers that utilizes a large amount of resource capacity; and
assigning the identified customer to an IP of the one or more IPs, wherein the IP only processes data for the identified customer.

16. The non-transitory computer-readable medium of claim 15, wherein each of the one or more IPs is deployed in its own isolated environment, and wherein each of the IPs is isolated by data flow and hardware.

17. The non-transitory computer-readable medium of claim 11, wherein the steps comprise:
deploying an IP, wherein the IP comprises an instance of the service, and wherein the IP is independent of the service;
installing debugging code in the IP; and
performing debugging of the service via the IP.

18. The non-transitory computer-readable medium of claim 11, wherein the service is an enforcement system adapted to enforce policy relating to security of the cloud-based system and the plurality of customers.

19. The non-transitory computer-readable medium of claim 11, wherein any of the plurality of customers can be assigned to any of the one or more IPs, wherein assigning a customer to an IP causes the IP to process all requests for the customer.

20. The non-transitory computer-readable medium of claim 11, wherein any number of IPs can be deployed, and wherein each of the IPs can be configured to ingest all the data flowing through the service.
